(19) United States
(12) Patent Application Publication
(10) Pub. No.: US 2009/0193904 A1
(43) Pub. Date: Aug. 6, 2009

(54) SENSOR ABNORMALITY DETECTION APPARATUS AND SENSOR ABNORMALITY DETECTION METHOD

(75) Inventors: Hideyuki TAKAHASHI, Kawasaki-shi (JP); Tadao KOBAYASHI, Kawasaki-shi (JP); Koji OGUCHI, Kawasaki-shi (JP); Yoshiaki MOROGUCHI, Kawasaki-shi (JP)

Correspondence Address: ROSSI, KIMMS & McDOWELL LLP., 20609 Gordon Park Square, Suite 150, Ashburn, VA, 20147, US

(73) Assignee: MITSUBISHI FUSO TRUCK AND BUS CORPORATION, Kawasaki (JP)

(21) Appl. No.: 12/370,979

(22) Filed: Feb. 13, 2009

Related U.S. Application Data
(63) Continuation of application No. PCT/JP2007/074105, filed on Dec. 14, 2007.

(30) Foreign Application Priority Data
Dec. 26, 2006 (JP) 2006-350133

(51) Int. Cl. G01L 13/02

(52) U.S. Cl. 73/716

(57) ABSTRACT

A filter upstream-side pressure sensor detects the pressure on an upstream side of a filter. A filter downstream-side pressure calculating device subtracts an actual measurement value of the pressure difference between the upstream side and the downstream side of the filter from a pressure value on the upstream side of the filter. Based on this subtraction, the filter downstream-side pressure calculating device calculates a pressure value on the downstream side of the filter. A filter downstream-side pressure estimating device estimates a pressure value on the downstream side of the filter. An abnormality detection device compares the difference between the calculated pressure value and the estimated pressure value with a threshold. If the difference exceeds the threshold, it is determined that at least one of a differential pressure sensor and the filter upstream-side pressure sensor is not working normally.

### CROSS REFERENCE TO RELATED APPLICATIONS$

This is a Continuation Application of PCT Application No. PCT/JP2007/074105, filed Dec. 14, 2007, which was published under PCT Article 21(2) in Japanese.

This application is based upon and claims the benefit of priority from prior Japanese Patent Application No. 2006-350133, filed Dec. 26, 2006, the entire contents of which are incorporated herein by reference.

### BACKGROUND OF THE INVENTION

1. Field of the Invention

The present invention relates to a sensor abnormality detection apparatus used in an exhaust filtering apparatus such as a DPF and the like, and a sensor abnormality detection method.

2. Description of the Related Art

An exhaust filtering apparatus, for example, a diesel particulate filter (DPF) apparatus is provided with a filter inside the apparatus, and traps particulates contained in the exhaust of an engine by means of a filter to clean the exhaust. The filter is clogged by the trapped particulates, and hence a soot content is appropriately burnt automatically, or it is urged to replace or clean the filter. Further, an increase in the exhaust resistance in the DPF apparatus causes an increase in the back pressure, and adversely affects the engine control in some cases.

Thus, in the DPF apparatus, various sensors such as a differential pressure sensor for measuring a pressure difference between the upstream side and the downstream side of the filter are provided, and it is judged whether or not the filter is clogged by the particulates on the basis of values from the differential pressure sensor and the like. Further, when the filter is clogged, the DPF apparatus outputs a signal for urging the driver to perform manual burning, or transmits such a signal to a control apparatus so as to utilize the control apparatus for engine control.

As described above, the sensors provided in the DPF apparatus have a great influence on the traveling of a vehicle, and the environment, and thus sensors are important. On the other hand, a change in temperature and a variation in pressure which are received by the sensors during the use are very great, and hence it is conceivable that the sensors become unable to operate normally in some cases. If assumedly various control operations are performed on the basis of a value output from a sensor in a state where the sensor is not operating normally, a desired result cannot be obtained. Thus, a method for judging whether or not various sensors function normally while the vehicle is running has been invented.

In, for example, Jpn. Pat. Appln. KOKAI Publication No. 2005-307880, an invention of an apparatus for detecting an abnormality of a differential pressure sensor for detecting a pressure difference between the upstream side and the downstream side of an exhaust cleaning filter is described. In this apparatus, the pressure difference between the upstream side and the downstream side of the exhaust cleaning filter is calculated from the operation state of the internal combustion engine, and a difference between the calculated pressure difference and the value detected by the differential pressure sensor is obtained. Further, it is detected that there is an abnormality in the differential pressure sensor if the obtained difference exceeds a threshold.

### BRIEF SUMMARY OF THE INVENTION

However, it is actually possible that even if the operation state of the internal combustion engine is substantially the same, the actual running state of the vehicle is largely different. That is, a case where the vehicle travels stably at a high speed and a case where the vehicle is goes up a hill at a lower gear are quite different from each other in the travel distance and in the combustion state even when the operation state of the internal combustion engine is substantially the same.

In the conventional abnormality detection apparatus, an amount of the deposit of particulates on the exhaust cleaning filter is used to calculate the pressure difference. However, the amount of the deposit of the particulates on the exhaust cleaning filter is obtained from the operation state of the internal combustion engine, and hence a case where a large difference appears in the amount of the deposit of the particulates is conceivable. Accordingly, when it is detected that there is an abnormality in the differential pressure sensor on the basis of the amount of the deposit of the particulates, there is a problem that the variation in the detection results is large, and the detection results lack in the appropriateness.

An object of the present invention is to provide an apparatus for detecting an abnormality of a sensor in an exhaust filtering apparatus, the apparatus being capable of solving the above problem, and accurately detecting an abnormality of the sensor at all times, and a method of detecting the abnormality of the sensor.

In order to solve the problem described above, in the present invention, the sensor abnormality detection apparatus, and the sensor abnormality detection method are configured as follows.

1. A sensor abnormality detection apparatus is configured to comprise: a filter which is provided in an exhaust path of an internal combustion engine, and collects particulates contained in the exhaust; a differential pressure sensor for detecting a pressure difference between the upstream side and the downstream side of the filter; a filter upstream-side pressure sensor for detecting a pressure on the upstream side of the filter; filter downstream-side pressure calculating means for subtracting a value of the pressure difference between the upstream side and the downstream side of the filter detected by the differential pressure sensor from an actual measurement value of the pressure on the upstream side of the filter detected by the filter upstream-side pressure sensor to calculate a pressure value on the downstream side of the filter; filter downstream-side pressure estimating means for estimating a pressure value on the downstream side of the filter on the basis of an operation state of the internal combustion engine; and abnormality detection means for comparing a difference between the calculated pressure value calculated by the filter downstream-side pressure calculating means and the estimated pressure value estimated by the filter downstream-side pressure estimating means with a threshold thereby to detect that a function of at least one of the differential pressure sensor and the filter upstream-side pressure sensor is not performed normally.

2. In the sensor abnormality detection apparatus according to 1, the filter downstream-side pressure estimating means estimates the pressure value on the downstream side of the filter on the basis of an exhaust flow rate of the exhaust discharged from the internal combustion engine, and a value of the atmospheric pressure.

3. In the sensor abnormality detection apparatus according to 1, the filter downstream-side pressure estimating means estimates the pressure value on the downstream side of the filter on the basis of an intake-side pressure value (boost pressure) of the internal combustion engine, and a value of the atmospheric pressure.

4. In the sensor abnormality detection apparatus according to any one of 1 to 3, the abnormality detection means determines, when the difference between the calculated pressure value calculated by the filter downstream-side pressure calculating means and the estimated pressure value estimated by the filter downstream-side pressure estimating means continuously exceeds the threshold for a predetermined period of time, that a function of at least one of the differential pressure sensor and the filter upstream-side pressure sensor is not performed normally.

5. A sensor abnormality detection method used in an exhaust filtering apparatus in which a filter is provided in an exhaust path of an internal combustion engine, and which collects particulates contained in the exhaust by means of the filter is configured to comprise: causing a differential pressure sensor for detecting a pressure difference between the upstream side and the downstream side of the filter to detect the pressure difference between the upstream side and the downstream side of the filter; causing a filter upstream-side pressure sensor for detecting a pressure on the upstream side of the filter to detect the pressure on the upstream side of the filter; causing filter downstream-side pressure calculating means to subtract a value of the pressure difference between the upstream side and the downstream side of the filter detected by the differential pressure sensor from an actual measurement value of the pressure on the upstream side of the filter detected by the filter upstream-side pressure sensor to calculate a pressure value on the downstream side of the filter; causing filter downstream-side pressure estimating means for estimating a pressure value on the downstream side of the filter on the basis of an operation state of the internal combustion engine to estimate the pressure value on the downstream side of the filter; and obtaining a pressure difference between the calculated pressure value calculated by the filter downstream-side pressure calculating means and the estimated pressure value estimated by the filter downstream-side pressure estimating means, and causing abnormality detection means to compare the pressure difference with a threshold thereby to detect, from the comparison result, that a function of at least one of the differential pressure sensor and the filter upstream-side pressure sensor is not performed normally.

6. In the sensor abnormality detection method according to 5, the estimated pressure value estimated by the filter downstream-side pressure estimating means is estimated on the basis of an exhaust flow rate of the exhaust discharged from the internal combustion engine, and a value of the atmospheric pressure.

7. In the sensor abnormality detection method according to 5, the estimated pressure value estimated by the filter downstream-side pressure estimating means is estimated on the basis of an intake-side pressure value (boost pressure) of the internal combustion engine, and a value of the atmospheric pressure.

8. In the sensor abnormality detection method according to any one of 5 to 7, when that a function of at least one of the differential pressure sensor and the filter upstream-side pressure sensor is not performed normally is detected, if the detection result continues to exceed a predetermined period of time, the detection result is determined by the abnormality detection means.

### Advantages of the Invention

The sensor abnormality detection apparatus, and the sensor abnormality detection method according to the present invention provide the following advantages.

The calculated pressure value on the downstream side of the filter is calculated from the filter upstream-side pressure sensor and the differential pressure sensor. The estimated pressure value on the downstream side of the filter is obtained on the basis of an exhaust flow rate of the exhaust in the internal combustion engine in such a state. Further, a difference between the calculated pressure value and the estimated pressure value is compared with a threshold, and hence an abnormality of the sensors can be detected at all times from various conditions which can be obtained at the present time. Accordingly, information on the past operation state of the internal combustion engine is not required, and hence the sensor abnormality detection can be performed directly and accurately.

The filter downstream-side pressure estimating means estimates the pressure value on the downstream side of the filter on the basis of an exhaust flow rate of the exhaust discharged from the internal combustion engine, and a value of the atmospheric pressure. The exhaust flow rate and the value of the atmospheric pressure can be securely calculated by using the values of the intake air mass/flow rate obtained by an intake air sensor, the fuel injection amount according to an instruction value of the ECU, the DPF inlet temperature detected by the temperature sensor, the DPF upstream-side pressure detected by the DPF upstream-side pressure sensor, and the atmospheric pressure sensor. Accordingly, it is possible to obtain the estimated pressure value on the downstream side of the filter on the basis of only the output values from the sensors, and the value calculated from the instruction value of the ECU.

As described above, in the sensor abnormality detection apparatus according to the present invention, the estimated pressure value on the downstream side of the filter is calculated on the basis of the reliable numerical values. Therefore, it is possible to detect an abnormality of the pressure sensors more securely as compared with a filter downstream pressure estimating method in which a result is obtained on the basis of other estimated values such as a deposit amount of the particulates.

Further, the filter downstream-side pressure estimating means estimates the pressure value on the downstream side of the filter on the basis of an intake-side pressure value (boost pressure) of the internal combustion engine, and a value of the atmospheric pressure. The estimated pressure value on the downstream side of the filter is obtained by using the boost pressure, and hence it is possible to calculate the estimated pressure value on the downstream side of the filter without using a pressure value on the upstream side of the DPF detected by the DPF upstream-side pressure sensor which is the object of the abnormality detection. Accordingly, it is possible to detect an abnormality of the pressure sensors more securely.

The abnormality of the sensor is determined after an elapse of a predetermined period of time, and hence the reliability of the detection apparatus can be improved.

### BRIEF DESCRIPTION OF THE SEVERAL VIEWS OF THE DRAWING

FIG. 1 is a view showing a configuration of an engine provided with an example of an abnormality detection apparatus according to the present invention.

FIG. 2 is a block diagram showing the abnormality detection apparatus.

FIG. 3 is a block diagram showing a control apparatus.

FIG. 4 is a block diagram showing an abnormality detection means.

FIG. 5 is a graph for obtaining outlet pressure of a DPF apparatus.

FIG. 6 is a flowchart showing an operation of the abnormality detection apparatus.

### DETAILED DESCRIPTION OF THE INVENTION

An embodiment of a sensor abnormality detection apparatus according to the present invention will be described below with reference to the accompanying drawings.

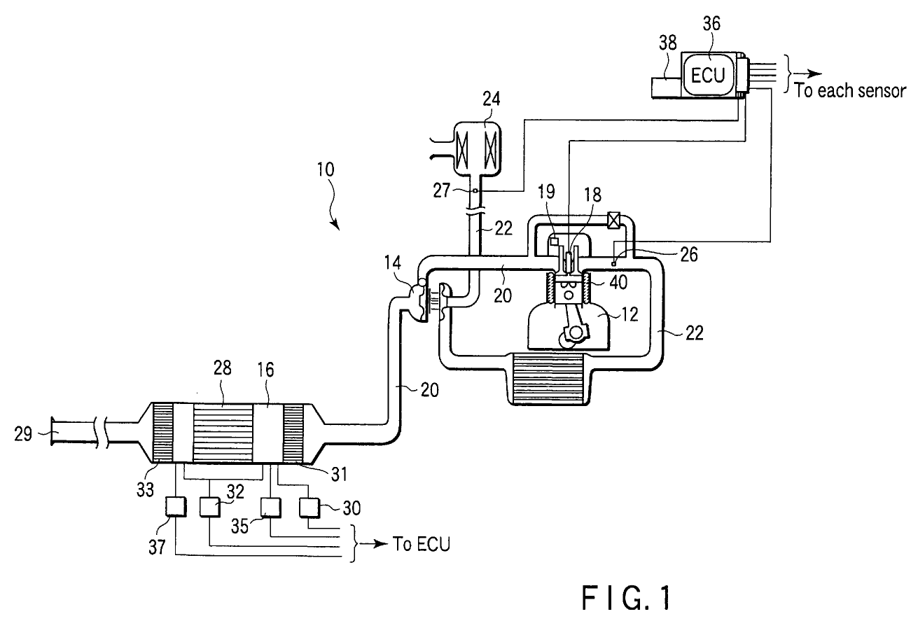

FIG. 1 shows a configuration example of an engine 12 as an internal combustion engine provided with a sensor abnormality detection apparatus 10. The engine 12 is a diesel engine, and is provided with a turbocharger 14, a DPF apparatus 16, a fuel supply system 18, and the like. The turbocharger 14 is connected to an exhaust pipe 20 serving as an exhaust path, and an inlet pipe 22 serving as an inlet path. The turbocharger 14 pressurizes the outside air sucked through an air cleaner 24 by utilizing the exhaust pressure, and feeds the pressurized air to the engine 12.

The inlet pipe 22 is provided with an intake pressure sensor 26 for detecting pressure inside the inlet pipe 22, i.e., charging pressure (boost pressure) generated by the turbocharger 14. Incidentally, the engine 12 is not limited to the diesel engine, and may be a naturally aspirated engine provided with no turbocharger 14.

The DPF apparatus 16 is cylindrical, and is provided with a filter 28 therein. In the DPF apparatus 16, the upstream side thereof is connected to the exhaust side of the turbocharger 14, and the downstream side thereof communicates with an exhaust port 29 of the vehicle. The filter 28 is constituted of a ceramic filter or the like. In the filter 28, a fine hole part is formed in the surface, and traps particulates contained in the exhaust. An upstream-side pressure sensor 30, a differential pressure sensor 32, an upstream-side temperature sensor 35, and a downstream-side temperature sensor 37 are attached to the DPF apparatus 16. Further, catalyst apparatuses 31 and 33 and the like are coupled to parts in front of and behind the filter 28.

The upstream-side pressure sensor 30 is attached to a part of the DPF apparatus 16 on the upstream side, and detects an upstream-side pressure value of the filter 28. The differential pressure sensor 32 detects a pressure difference caused between the upstream side and the downstream side of the filter 28. The upstream-side temperature sensor 35 measures a temperature of the upstream side of the DPF apparatus 16, i.e., an exhaust temperature. The downstream-side temperature sensor 37 measures a temperature of the downstream side of the DPF apparatus 16.

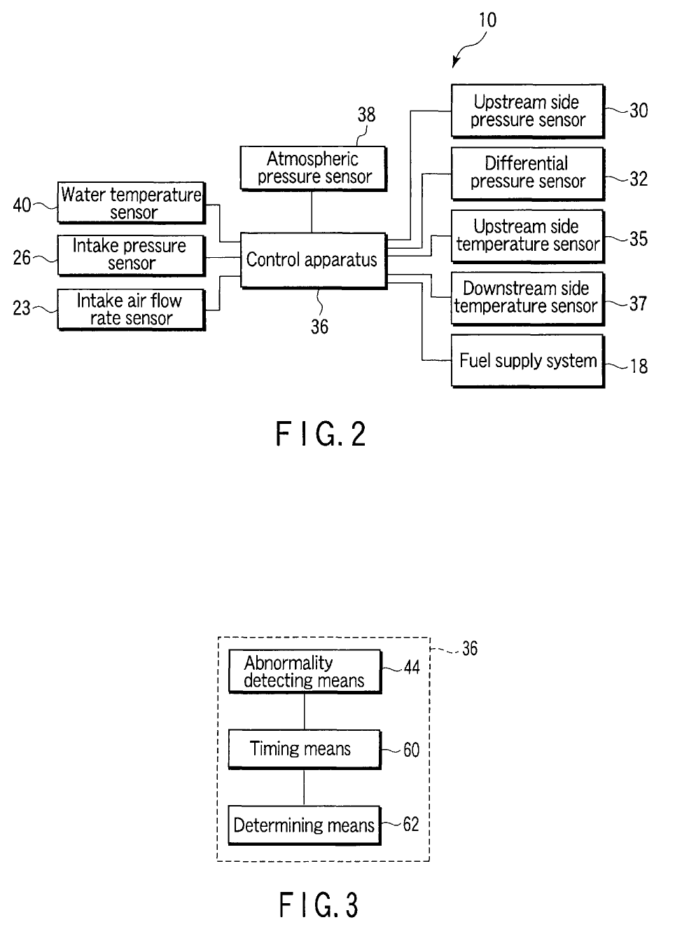

The sensors are connected to a control apparatus 36 (electronic control unit [ECU]) as shown in FIG. 2. Further, various sensors such as an atmospheric pressure sensor 38 for detecting a value of the atmospheric pressure, a water temperature sensor 40 for detecting a water temperature of the cooling water, an intake air flow rate sensor 23 for measuring a flow rate in the inlet pipe 22, and the like are connected to the control apparatus 36 as shown in FIG. 2. Values detected by the sensors are sent to the control apparatus 36.

The fuel supply system 18 is a fuel injection system for injecting fuel. The fuel supply system 18 injects a predetermined amount of fuel into the inside of the engine 12 in accordance with an instruction from the control apparatus 36.

Further, the control apparatus 36 includes an abnormality detection means 44 for detecting an abnormality of the sensors, a timing means 60, and a determination means 62 as shown in FIG. 3.

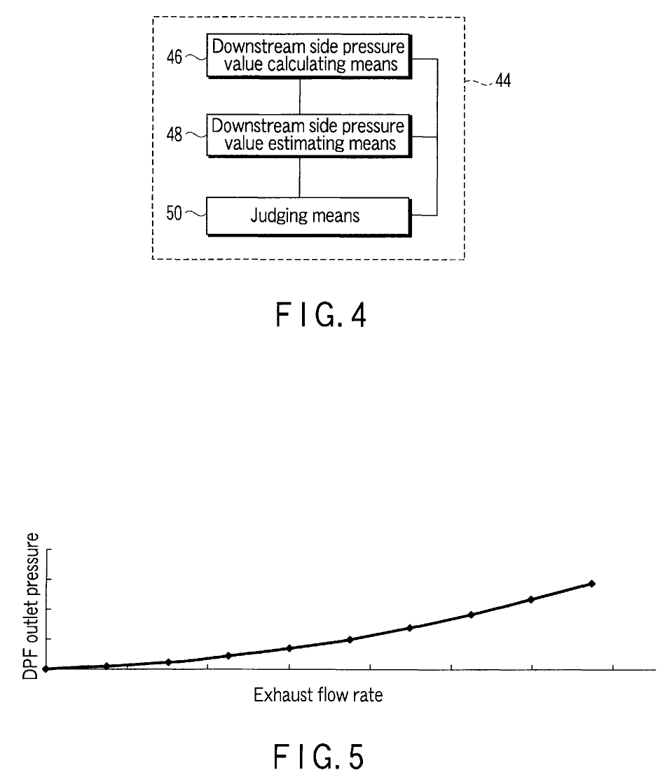

The abnormality detection means 44 is constituted of a downstream-side pressure value calculating means 46, a downstream-side pressure value estimating means 48, a judgment means 50 for judging an abnormality of the sensors, and the like as shown in FIG. 4.

The downstream-side pressure value calculating means 46 obtains an upstream-side pressure value of the filter 28 from the upstream-side pressure sensor 30, and obtains a pressure difference between the upstream side and the downstream side of the filter 28 from the differential pressure sensor 32. Further, the downstream-side pressure value calculating means 46 subtracts the pressure difference from the upstream-side pressure value to calculate a value of the pressure (absolute pressure) caused on the downstream side of the filter 28.

The downstream-side pressure value estimating means 48 obtains an exhaust flow rate of the exhaust discharged from the engine 12, and calculates the outlet pressure generated on the downstream side of the filter 28 by the exhaust from the exhaust flow rate of the exhaust by using a conversion map shown in FIG. 5. Further, the downstream-side pressure value estimating means 48 adds a detection value of the atmospheric pressure sensor 38 to the outlet pressure to thereby estimate a pressure value (absolute pressure) on the downstream side of the filter 28.

The exhaust flow rate of the exhaust discharged from the engine 12 is calculated from the intake air flow rate detected by the intake air flow rate sensor 23, a supply amount of the fuel supplied from the fuel supply system 18 to the engine 12 at that time, an inlet temperature of the DPF apparatus 16 detected by the upstream-side temperature sensor 35, and a value of the upstream-side pressure of the DPF apparatus 16 detected by the upstream-side pressure sensor 30.

Further, the downstream-side pressure value estimating means 48 can also calculate the outlet pressure caused on the downstream side of the filter 28 from the boost pressure (intake pressure) and the like detected by the intake pressure sensor 26 by using the conversion map, and can estimate the pressure value (absolute pressure) on the downstream side of the filter 28 by adding the detected value of the atmospheric pressure sensor 38 to the outlet pressure. The conversion map for conversion from the boost pressure to the outlet pressure caused on the downstream side of the filter 28 is obtained in advance by a test.

The judgment means 50 obtains a difference between a pressure value of the downstream side of the filter 28 calculated by the downstream-side pressure value calculating means 46 and an estimated pressure value of the downstream side of the filter 28 estimated by the downstream-side pressure value estimating means 48. Further, the judgment means 50 compares the value of the difference with a threshold, and when the difference is larger than the threshold, the judgment means 50 judges that the value sent from at least one of the upstream-side pressure sensor 30 and the differential pressure sensor 32 is not normal. Incidentally, the threshold is a constant univocally determined from the filter 28, and a state and the like where the filter 28 is provided.

Further, the control apparatus 36 is provided with a timing means 60, and an abnormality determination means 62. The timing means 60 measures the duration time for which the judgment that the value sent from at least one of the upstream-side pressure sensor 30 and the differential pressure sensor 32 is not normal continues.

The determination means 62 judges whether or not the time measured by the timing means 60 for the judgment that the value sent from the sensor is not normal has continued for a predetermined period of time (determined time). Upon confirming that the judgment result that the value sent from the sensor is not normal has continued for the predetermined period of time, the determination means 62 determines that an abnormality has occurred in the sensors. The determined time is, for example, 10 seconds. Incidentally, the determined time can be appropriately changed.

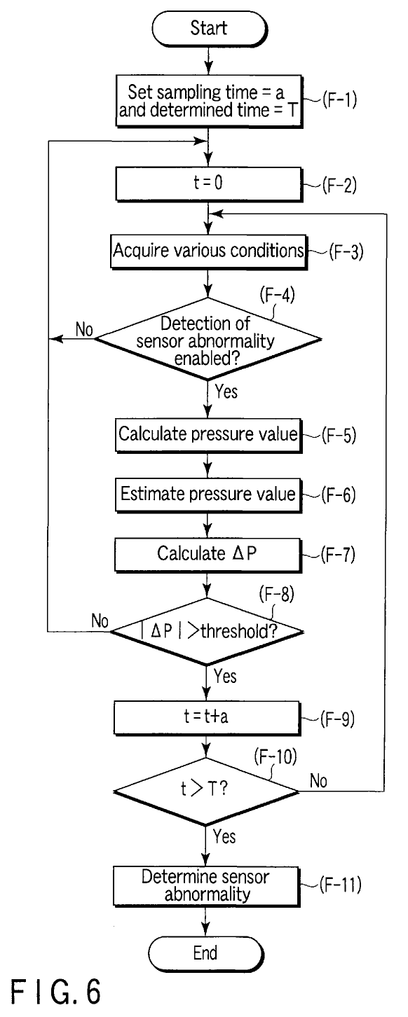

Next, an abnormality detection method using the sensor abnormality detection apparatus 10 will be described below by using the flowchart shown in FIG. 6.

First, the sampling time a, and the determined time T are determined (F-1). The sampling time a is a time interval of repetition when the pressure difference and the threshold are compared with each other repeatedly. The time T is the time (determined time) needed to determine the abnormality. When the time is input, t is set at 0 as an initial value (F-2).

Then, the control apparatus 36 acquires detection values sent from the water temperature sensor 40, the atmospheric pressure sensor 38, an engine rotational speed sensor, an intake air temperature sensor (both of which are not shown), and the like (F-3). The control section 36 judges whether or not a condition which enables detection of an abnormality of the pressure sensors provided in the DPF apparatus 16 is given. That is, the control section 36 confirms that it is not immediately after the engine has been started, that the engine is not operating abnormally, or that an abnormality has not occurred in any one of the sensors.

In F-4, when the collateral condition is established, and it is judged that detection of an abnormality of the pressure sensors provided in the DPF apparatus 16 is enabled, the flow is advanced to (F-5). In F-5, the downstream-side pressure value calculating means 46 subtracts the pressure difference obtained by the differential pressure sensor 32 from the upstream-side pressure value obtained by the upstream-side pressure sensor 30 to calculate a pressure value (absolute pressure) occurring on the downstream side of the filter 28.

Then, the downstream-side pressure value estimating means 48 calculates the outlet pressure occurring on the downstream side of the filter 28 from the exhaust flow rate by using the conversion map shown in FIG. 5. Further, the downstream-side pressure value estimating means 48 adds a detection value of the atmospheric pressure sensor 38 to the outlet pressure to thereby estimate a pressure value (absolute pressure) on the downstream side of the filter 28 (F-6).

When the calculated pressure value and the estimated pressure value are obtained, a difference ΔP between the values is calculated (F-7). Further, the judgment means 50 compares the value of the difference ΔP with the threshold (F-8). When the difference ΔP is smaller than the threshold, the flow is returned to F-2.

On the other hand, when the difference ΔP is larger than the threshold, the flow is advanced to F-9, a is added to t, and the resultant is newly made t. Then, it is judged whether or not t exceeds T. When t does not exceed T, the flow is returned to F-3. When the flow is returned to F-3, the operation starting from F-3 is performed again. When the difference ΔP is larger than the threshold, a is further added to t, and the operation is repeated in a circulative manner until t exceeds T.

While the above operation is repeatedly performed in the circulative manner, when the difference ΔP becomes smaller than the threshold, the flow is made to go out from the circulation in F-8, and is returned to F-2. Further, t is newly made 0, and the operation is restarted.

On the other hand, when t exceeds T in F-10, the flow is advanced to F-11, the determination means 62 determines that the value sent from the sensor is not normal, and an abnormality is occurring in at least one of the upstream-side pressure sensor 30 and the differential pressure sensor 32.

As described above, according to the sensor abnormality detection apparatus 10, an abnormality of the sensor can be judged by the comparison with the threshold. Furthermore, the threshold is a constant univocally determined from the filter 28, and hence the threshold is stable without being affected by the operation state and the like of the internal combustion engine, and detection of an abnormality of the sensor can be securely performed.

Further, the downstream-side pressure value calculating means 46 obtains the pressure value on the upstream side of the filter 28 from the upstream-side pressure sensor 30, and obtains the pressure difference between the upstream side and the downstream side of the filter 28 from the differential pressure sensor 32. Further, the downstream-side pressure value calculating means 46 subtracts the pressure difference from the upstream-side pressure value to calculate the pressure value (absolute pressure) occurring on the downstream side of the filter 28. Accordingly, the calculated value is a value in which pressure varying factors on the upstream side of the filter 28 cancel each other out, and substantially represents the deposit amount of the particulates on the filter 28 in the state of the engine 12 at that time.

Further, the downstream-side pressure value estimating means 48 obtains the exhaust flow rate of the exhaust discharged from the engine 12, and calculates the outlet pressure generated on the downstream side of the filter 28 by the exhaust from the exhaust flow rate of the exhaust by using the conversion map shown in FIG. 5. Further, the downstream-side pressure value estimating means 48 adds the detection value of the atmospheric pressure sensor 38 to the value of the outlet pressure to thereby estimate the pressure value (absolute pressure) on the downstream side of the filter 28. In the obtained estimated pressure value, the influence of the amount of the deposit of the particulates on the filter 28 is not contained at all. Accordingly, an accurate pressure value in which an error concomitant with the deposit amount calculation is not present can be obtained.

By virtue of the configuration described above, the abnormality detection apparatus 10 according to the present invention can appropriately detect an abnormality of a sensor irrespective of an amount of particulates deposited on the filter 28.

Further, the exhaust flow rate of the exhaust is calculated on the basis of the detection values from the sensors, and the control signal (fuel injection amount) from the control apparatus 36, and hence a highly reliable value can be obtained. Further, since the pressure value (absolute pressure) on the downstream side of the filter 28 is estimated on the basis of such a numerical value, it is possible to securely detect an abnormality of the pressure sensor.

Further, when the estimated downstream pressure value is obtained by calculating the pressure value (absolute pressure) on the downstream side of the filter 28 from the boost pressure (intake pressure) and the like detected by the intake pressure sensor 26, a detection value from the sensor which is the object of the abnormality detection is not used, and hence it is possible to detect an abnormality of the pressure sensor with higher reliability.

The present invention can be utilized for the apparatus for detecting an abnormality of a sensor in the exhaust filtering apparatus, and a method of detecting the abnormality of the sensor.

What is claimed is:

1. A sensor abnormality detection apparatus comprising:
a filter which is provided in an exhaust path of an internal combustion engine, and collects particulates contained in the exhaust;
a differential pressure sensor for detecting a pressure difference between the upstream side and the downstream side of the filter;
a filter upstream-side pressure sensor for detecting a pressure on the upstream side of the filter;
filter downstream-side pressure calculating means for subtracting a value of the pressure difference between the upstream side and the downstream side of the filter detected by the differential pressure sensor from an actual measurement value of the pressure on the upstream side of the filter detected by the filter upstream-side pressure sensor to calculate a pressure value on the downstream side of the filter;
filter downstream-side pressure estimating means for estimating a pressure value on the downstream side of the filter on the basis of an operation state of the internal combustion engine; and
abnormality detection means for comparing a difference between the calculated pressure value calculated by the filter downstream-side pressure calculating means and the estimated pressure value estimated by the filter downstream-side pressure estimating means with a threshold thereby to detect that a function of at least one of the differential pressure sensor and the filter upstream-side pressure sensor is not performed normally.

2. The sensor abnormality detection apparatus according to claim 1, wherein the filter downstream-side pressure estimating means estimates the pressure value on the downstream side of the filter on the basis of an exhaust flow rate of the exhaust discharged from the internal combustion engine, and a value of the atmospheric pressure.

3. The sensor abnormality detection apparatus according to claim 1, wherein the filter downstream-side pressure estimating means estimates the pressure value on the downstream side of the filter on the basis of an intake-side pressure value (boost pressure) of the internal combustion engine, and a value of the atmospheric pressure.

4. The sensor abnormality detection apparatus according to any one of claims 1 to 3, wherein the abnormality detection means determines, when the difference between the calculated pressure value calculated by the filter downstream-side pressure calculating means and the estimated pressure value estimated by the filter downstream-side pressure estimating means continuously exceeds the threshold for a predetermined period of time, that a function of at least one of the differential pressure sensor and the filter upstream-side pressure sensor is not performed normally.

5. A sensor abnormality detection method used in an exhaust filtering apparatus in which a filter is provided in an exhaust path of an internal combustion engine, and which collects particulates contained in the exhaust by means of the filter comprising:
causing a differential pressure sensor for detecting a pressure difference between the upstream side and the downstream side of the filter to detect the pressure difference between the upstream side and the downstream side of the filter;
causing a filter upstream-side pressure sensor for detecting a pressure on the upstream side of the filter to detect the pressure on the upstream side of the filter;
causing filter downstream-side pressure calculating means to subtract a value of the pressure difference between the upstream side and the downstream side of the filter detected by the differential pressure sensor from an actual measurement value of the pressure on the upstream side of the filter detected by the filter upstream-side pressure sensor to calculate a pressure value on the downstream side of the filter;
causing filter downstream-side pressure estimating means for estimating a pressure value on the downstream side of the filter on the basis of an operation state of the internal combustion engine to estimate the pressure value on the downstream side of the filter; and
obtaining a pressure difference between the calculated pressure value calculated by the filter downstream-side pressure calculating means and the estimated pressure value estimated by the filter downstream-side pressure estimating means, and causing abnormality detection means to compare the pressure difference with a threshold thereby to detect, from the comparison result, that a function of at least one of the differential pressure sensor and the filter upstream-side pressure sensor is not performed normally.

6. The sensor abnormality detection method according to claim 5, wherein the estimated pressure value estimated by the filter downstream-side pressure estimating means is estimated on the basis of an exhaust flow rate of the exhaust discharged from the internal combustion engine, and a value of the atmospheric pressure.

7. The sensor abnormality detection method according to claim 5, wherein the estimated pressure value estimated by the filter downstream-side pressure estimating means is estimated on the basis of an intake-side pressure value (boost pressure) of the internal combustion engine, and a value of the atmospheric pressure.

8. The sensor abnormality detection method according to any one of claims 5 to 7, wherein when that a function of at least one of the differential pressure sensor and the filter upstream-side pressure sensor is not performed normally is detected, if the detection result continues to exceed a predetermined period of time, the detection result is determined by the abnormality detection means.
